(19) United States
(12) Patent Application Publication
(10) Pub. No.: US 2007/0159411 A1
(43) Pub. Date: Jul. 12, 2007

(54) Information-processing apparatus

(75) Inventor: Toshiyuki Hirota, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/640,978

(22) Filed: Dec. 19, 2006

(30) Foreign Application Priority Data
Dec. 22, 2005 (JP) 2005-370602

(51) Int. Cl. G09G 5/00

(52) U.S. Cl. 345/1.1

(57) ABSTRACT

According to one embodiment, an information-processing apparatus according to the present invention has a main unit, a display unit and a latch. The main unit has a holding part. The latch is provided on the display unit and has a latch part, wires, and first connectors. The wires are embedded in the latch part. The holding part has second connectors. The second connectors are connected to the first connectors when the holding part holds the latch.

### CROSS-REFERENCE TO RELATED APPLICATIONS

This application is based upon and claims the benefit of priority from Japanese Patent Application No. 2005-370602, filed Dec. 22, 2005, the entire contents of which are incorporated herein by reference.

### BACKGROUND

1. Field

One embodiment of the invention relates to an information-processing apparatus that has a latch for inhibiting the opening of, for example, the display unit of the apparatus.

2. Description of the Related Art

A type of a portable computer is known, in which the power supply to the display is turned off when the display is closed. This portable computer has a main unit, a display unit, a hinge unit, a latch, a lever, and a display switch. The display unit has a display. The hinge unit is provided between the main unit and the display unit. The latch inhibits the opening of the display unit. The latch can rotate the lever. The display switch is operated when the lever is rotated. The hinge unit enables the display unit to rotate with respect to the main unit.

In the portable computer, the latch rotates the lever when the display unit is closed, as is disclosed in, for example, Jpn. Pat. Appln. KOKAI Publication No. 2000-137549. As the latch is rotated, it pushes the switch. The supply of power to the display is thereby stopped.

Most portable computers have a power line, a signal line, and the like. The power line supplies power from the main unit to the display unit. The signal line sends control signals from the main unit to the display. In many cases, the power line and the signal line pass through the hinge unit, extending from the main unit to the display.

In the conventional portable computers, the power line and the signal line are packed in the hinge unit. The hinge unit is inevitably large to accommodate these lines. Since the hinge unit is large, the portable computer is large, too, as a whole.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the invention, showing the display unit remaining at a first position;

FIG. 2 is an exemplary perspective view of the portable computer shown in FIG. 1, showing the display unit remaining at a second position;

FIG. 3 is an exemplary sectional view of the portable computer shown in FIG. 1, showing the latch and the latch holder;

FIG. 4 is an exemplary system diagram showing the electrical connections in the portable computer of FIG. 1; and

FIG. 5 is an exemplary system diagram showing the electrical connections in a portable computer according to a second embodiment of this invention.

### DETAILED DESCRIPTION

Various embodiments according to the invention will be described hereinafter with reference to the accompanying drawings. In general, according to one embodiment of the invention, an information-processing apparatus according to the present invention has a main unit, a display unit and a latch. The main unit has a holding part. The latch is provided on the display unit and has a latch part, wires, and first connectors. The wires are embedded in the latch part. The holding part has second connectors. The second connectors are connected to the first connectors when the holding part holds the latch.

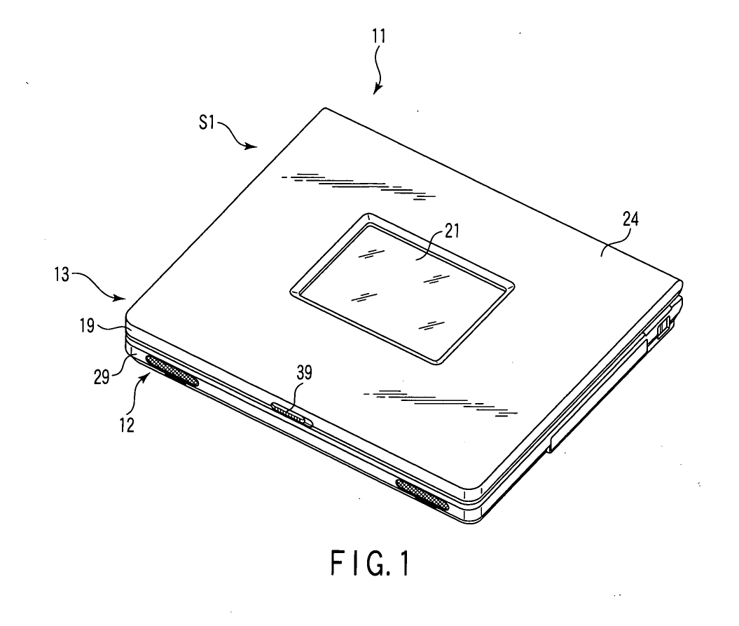

An information-processing apparatus according to-a first embodiment of this invention will be described, with reference to FIGS. 1 to 4.

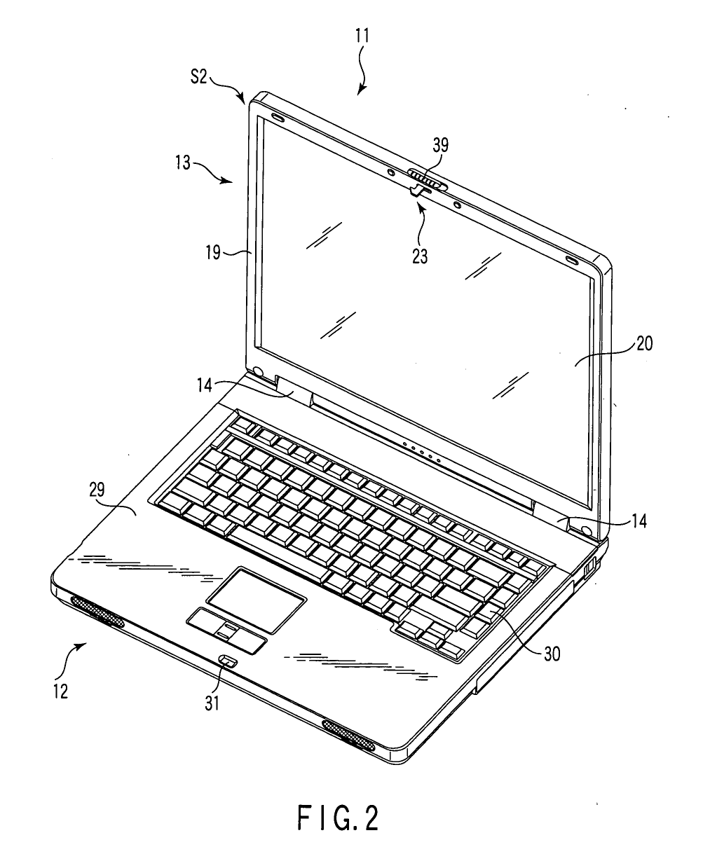

As shown in FIG. 1 or 2, a portable computer 11, or an information-processing apparatus, has a main unit 12, a display unit 13, and a hinge unit 14. The hinge unit 14 is provided between the main unit 12 and the display unit 13. The hinge unit 14 supports the display unit 13, enabling the display unit 13 to rotate. As FIGS. 1 and 2 show, the display unit 13 can be rotated between a first position S1 and a second position S2. At the first position S1, the display unit 13 closes the main unit 12. At the second position S2, the display unit 13 opens the main unit 12. The Display unit 13 has a first case (housing) 19, main display 20, and a sub-display 21. The display unit 13 has a latch 23. The latch 23 holds the display unit 13 at the first position S1.

The sub-display 21 is provided on, for example, the upper surface 24 of the first case 19. Hence, it can be seen as long as the display unit 13 stays at the first position S1.

Main unit 12 has a second case 29 and a keyboard 30. The keyboard 30 is mounted on the upper surface of the second case 29. The main unit 12 has a latch holder 31. The latch holder 31 can hold the latch 23 of the display unit 13.

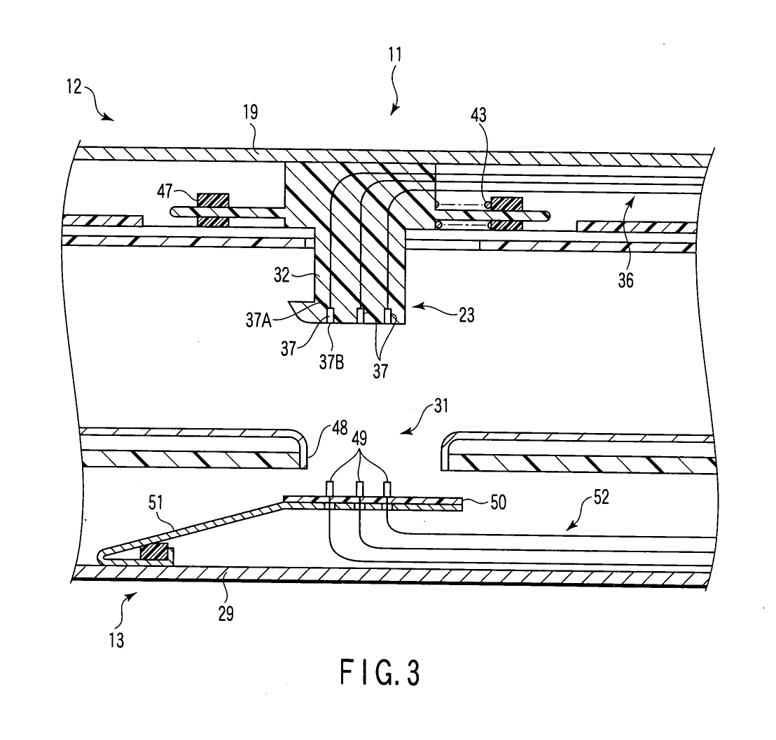

As shown in FIG. 3, the latch 23 has a latch part 32, three wires 36 of a first set, three connectors 37 of a first set, a support block 47, and a spring 43. The wires 36 are embedded in the latch part 32. The support block 47 supports the latch part 32, allowing the same to slide. The spring 43 biases the latch part 32 so that the latch part 32 may move to a closed position. As FIG. 1 shows, the latch 23 has a latch-releasing part 39. The connectors 37 of the first set have a proximal end 37A each. They are connected at the proximal end 37A to the three wires 36 of the first set, respectively. Each connector 37 of the first set is a female-type connector, having a distal end 37B that is opposed to the proximal end 27A. The distal ends 37B of the connectors 37 of the first set are exposed outside.

The latch holder 31 has an edge 48 of the second case 29, three connectors 49 of a second set, a base plate 50, a leaf spring 51, and three wires 52 of a second set. The connectors 49 of the second set are associated with the connectors 37 of the first set and provided on the base plate 50. The leaf spring 51 supports the base plate 50. The wires 52 are connected to the connectors 49 of the second set, respectively. Each connector 49 of the second set is a male-type connector. The latch part 32 is caught at the edge 48. If the latch part 32 is held by the latch holder 31, the leaf spring 51 biases the connectors 49 of the second set, from below toward the connectors 37 of the first set. As a result, the connectors 49 of the second set are connected to the connectors 37 of the first set, respectively. As long as the latch 23 remains held in the latch holder 31, the connectors 49 of the second set remain connected to with the connectors 37 of the first set.

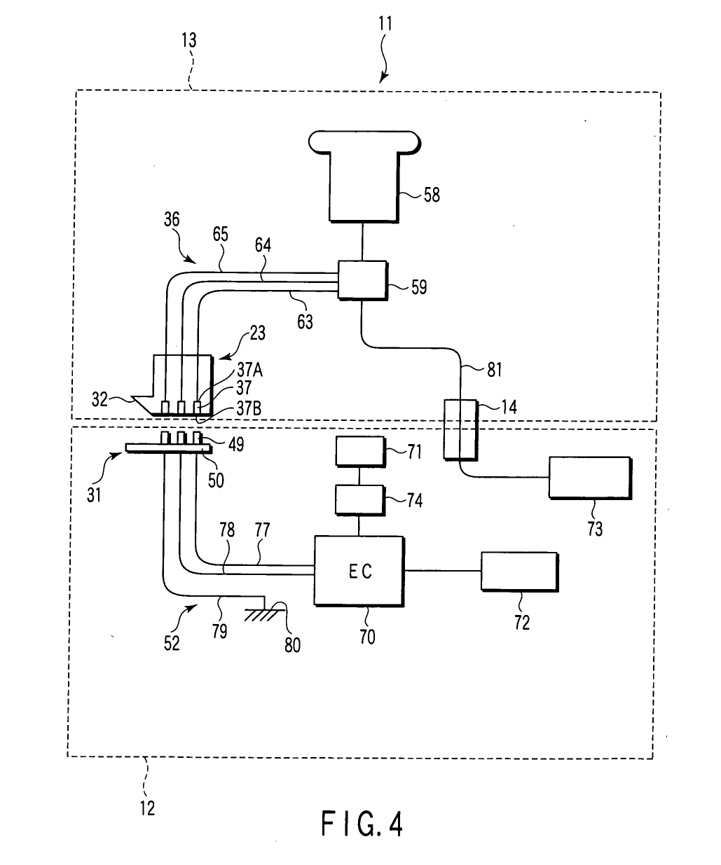

The electrical connections in the portable computer 11 will be described with reference to FIG. 4. The display unit 13 has a television antenna 58 and an amplifier 59 connected to the antenna 58. The three wires 36 of the first set are connected to the amplifier 59. The three wires 36 are used while the display unit 13 remains at the first position S1.

More specifically, the three wires 36 of the first set are, for example, a first line 63, a first signal line 64, and a first ground line 65. The first wire 63 supplies power to the amplifier 59. The first signal line 64 transmits a signal for turning on or off the power switch of the amplifier 59. The first ground line 65 connects the display unit 13 to the ground with respect to the main unit 12. In practice, the first wire 63 comprises two wires, one for supplying a current forward and the other for supplying a current backward. These two wires are depicted as if one, in FIG. 4.

The main unit 12 has an EC 70, a power-supply controller 74, a battery 71, a sensor 72, and a TV tuner 73. The EC 70 is connected to the three wires 52 of the second set. The power-supply controller 74 is connected to the EC 70. The battery 71 is connected to the power-supply controller 74. The sensor 72 is used as detecting unit. The TV tuner 73 is connected to the antenna 58. The sensor 72 can detect whether the display unit 13 is at the first position S1 or the second position S2. The EC 70 is a microcomputer, which can turn on and off the supply of power to the components of the portable computer 11.

The three wires 52 of the second set are a second wire 77, a second signal line 78, and a second ground line 79. The second wire 77 corresponds to the first wire 36 and supplies power to the amplifier 59. The second signal line 78 transmits a signal, which turns on or off the power switch of amplifier 59. The second ground line 79 connects the display unit 13 to the ground, with respect to the main unit 12. The second ground line 79 is connected to a ground layer 80. The ground layer 80 is formed by plating, for example, the inner surface of the bottom of the second case 29.

The antenna 58 and the TV tuner 73 are connected to each other by an antenna cable 81 that passes through the of hinge unit 14.

How the power-supply controller 74 and the EC 70 perform controls in the portable computer 11 will be explained, with reference to FIG. 4. For example, power is supplied or not supplied to the amplifier 59, in accordance with the position the display unit 13 takes. Thus, the amplifier 59 amplifies or does not amplify a signal that is to be transmitted.

As shown in FIG. 2, the antenna 58 is at a high position while the display unit 13 remains at the second position S2 and opened with respect to the main unit 12. Therefore, the antenna 58 can receive radio waves at high efficiency. In this case, any signal the antenna 58 receives has a large magnitude. The TV tuner 73 can therefore detect the signal even if the amplifier 59 has not amplified the signal. Hence, no power is supplied to the amplifier 59 by the power-supply controller 74 and the EC70 while the display unit 13 remains at the second position S2.

As shown in FIG. 1, the position of antenna 58 is at a low position while the display unit 13 remains at the first position S1 and closed with respect to the main unit 12. Inevitably, the antenna 58 cannot receive radio waves at high efficiency. In this case, the power-supply controller 74 and the EC70 supply power to the amplifier 59. Supplied with power, the amplifier 59 amplifies the signal it has received.

To be more specific, when the display unit 13 is rotated from the second position S2 to the first position S1, the latch holder 31 of the main unit 12 holds the latch 23 of the display unit 13. As a result, the first connectors 37 of the first set are connected to the connectors 49 of the second set, and the wires 36 of the first set are connected to the wires 52 of the second set are electrically connected to each other. The sensor 72 detects that the display unit 13 is at the first position S1 and generates a signal representing this. The signal is supplied to the EC 70 and thence to the power-supply controller 74. Then, the EC70 and the power-supply controller 74 supply power to the amplifier 59 through the first wire 63 and the second wire 77. The EC70 supplies a signal to the amplifier 59 through the second signal line 78 and the first signal line 64. This signal turns on the power switch of the amplifier 59.

When the power switch is turned on, the amplifier 59 amplifies the signal sent from the antenna 58. The signal thus amplified is transmitted to the TV tuner 73 through the antenna cable 81. The TV tuner 73 outputs a video signal to the sub-display 21. The sub-display 21 displays the TV image represented by the video signal.

When the display unit 13 is rotated from the first position S1 to the second position S2, the connectors 37 of the first set are disconnected from the connectors 49 of the second set. As a result, the first wire 63 is electrically disconnected from the second wire 77, and the first signal line 64 is electrically disconnected from the second signal line 78. When the sensor 72 detects that the display unit 13 has moved to the second position S2, the power-supply controller 74 and the EC70 stop supplying power to the amplifier 59. That is, the power switch of the amplifier 59 is turned off when the connectors 37 of the first set are physically and electrically disconnected from the connectors 49 of the second set. Thereby, the signal not amplified by the amplifier 59 is transmitted from the antenna 58 to the TV tuner 73.

In the information-processing apparatus according to the first embodiment, described above, the wires 36 of the first set and the connectors 37 of the first set are provided in the latch part 32, whereas the connectors 49 of the second set are provided in the latch holder 31. Therefore, the wires can pass through the latch 23 and the latch holder 31, not through the hinge unit 14 as in the conventional information-processing apparatus. Thus, the wires are not packed in the hinge unit 14. The hinge unit 14 can be therefore smaller than otherwise. The portable computer 11 can be small as a whole.

The connectors 37 of the first set, which are provided in the latch 23, are female-type comprises. The connectors 49 of the second set, which are provided in the latch holder 31, are male-type connectors. Hence, the connectors 37 of the first set will not project from the latch part 32. The user's fingers have no access to the connectors 37 of the first set. This prevents the connectors 37 from being broken.

The wires 36 of the first set are used while the display unit 13 remains at the first position S1. Therefore, it need not pass through the hinge unit 14. Thus, wires are not concentrated provided in the hinge unit 14. As a result, the hinge unit 14 can be small, which helps to render the portable computer 11 small.

The wires 36 of the first set are connected to the amplifier 59. Among these wires 36 is the first signal line 64 that supplies a signal from the main unit 12 to the amplifier 59 to turn on or off the amplifier 59. The first signal line 64 need not pass through the hinge unit 14, because it is used only while the display unit 13 remains at the first position S1.

The power-supply controller 74 and the EC70 turn on the amplifier 59 when the sensor 72 detects that the display unit 13 is at the first position S1. The amplifier 59 is turned off when the display unit 13 is rotated from the first position S1 to the second position S2 and the connectors 37 of the first set are therefore disconnected from the connectors 49 of the second set. Namely, the amplifier 59 is turned on and amplifies the input signal only when necessary. Thus, it is easy to control the amplifier 59.

The wires 36 of the first set include the first ground line 65. The first ground line 65 can therefore be positioned near the first signal line 64 and the first wire 63. Therefore, the first ground line 65 can absorb the electromagnetic waves radiated from the first wire 63 and first signal line 64.

In this embodiment, the wires 52 of the second set are provided in the main unit 12. Nonetheless, the wires 52 may be dispensed with. In this case, the EC70 and the like can be mounted on the substrate 50 on which the connectors 49 of the second set are provided. The wires 36 of the first set, which are provided in the latch part 32, may include signal lines that are connected to the main display 20 and the sub-display 21. These signal line can supply control signals from the main unit 12 to the main display 20 and the sub-display 21.

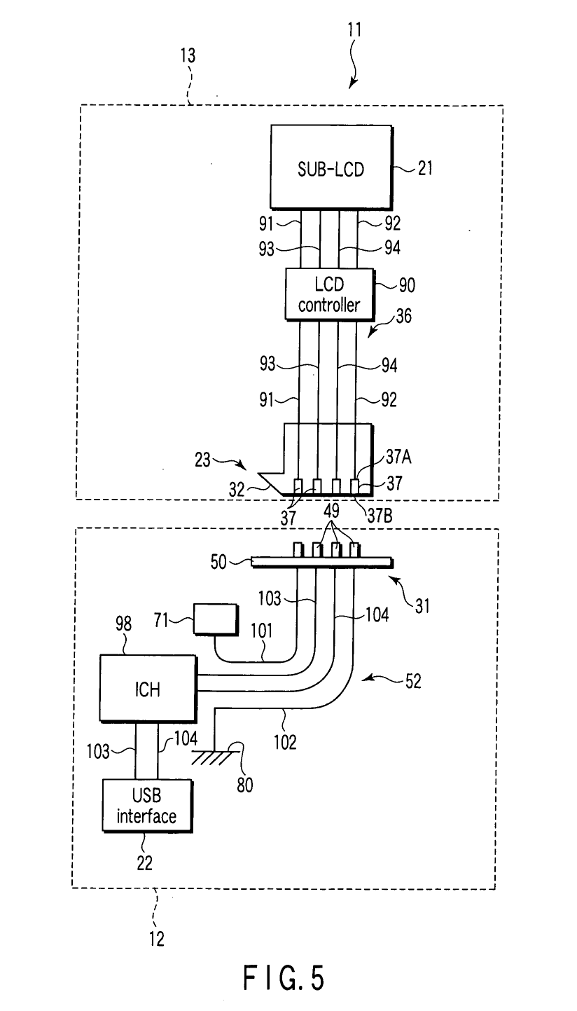

A portable computer 11, or an information-processing apparatus according to a second embodiment of this invention, will be described with reference to FIG. 5. This portable computer 11 differs from the one according to the first embodiment differs in the type of wires 36 of the first set and also in the kind of wires 52 of the second set, which are associated with the wires 36. The other components, which are identical to those of the first embodiment, are designated at the same reference numbers and will not described in detail.

In the second embodiment, the display unit 13 has an LCD controller 90 and a latch 23. The LCD controller 90 is controls the sub-display 21. The latch 23 has a latch part 32 and four wires 36 of a first set. Each wire 36 has its one end embedded in the latch part 32.

The four wires 36 of the first set are a first power line 91, a first ground line 92, a first USB positive line 93, and a first USB negative line 94. The first power line 91 supplies power to the sub-display 21. The first ground line 92 connects the sub-display 21 to the ground, with respect to the main unit 12. The first USB positive line 93 and the first USB negative line 94 are signal lines.

Through the first USB positive line 93 and the first USB negative line 94, data can be exchanged between a UBS interface 22 and the sub-display 21. Note that the UBS interface 22 is an external-connection interface. The first USB positive line 93 and the first USB negative line 94 are connected to the sub-display 21 by the LCD controller 90. Similarly, the first power line 91 and the first ground line 92 are connected to the sub-display 21, i.e., a display unit, by the LCD controller 90.

The main unit 12 has a latch holder 31, a USB interface 22, an ICH 98, a battery 71, and four wires 52 of a second set. The latch holder 31 is designed to hold the latch 23. The USB interface 22 is an external-connection interface to be connected to an external apparatus. The ICH 98 controls the USB interface 22. The battery 71 supplies power to the sub-display 21. The wires 52 of the second set are associated with the wires 36 of the first set. The latch holder 31 has four connectors 49 of the second set.

The four wires 52 of the second set are a second power line 101, a second ground line 102, a second USB positive line 103, and a second USB negative line 104. The second power line 101 supplies power to the sub-display 21. The second earth wire 102 connects the sub-display 21 to the ground layer 80 of the main unit 12.

How the sub-display 21 and the USB interface 22 are controlled will be explained with reference to FIG. 5.

As shown in FIG. 2, the sub-display 21 is not used while the display unit 13 remains at the second position S2. Thus, no power is supplied to the sub-display 21 as long as it is at the second position S2.

When the display unit 13 is rotated from the second position S2 to the first position S1, the sub-display 21 moves upwards. As a result, the latch holder 31 holds the latch 23. The connectors 37 of the first set are thereby connected to the connectors 49 of the second set. The battery 71 therefore supplies power to the LCD controller 90 through the first power line 91 and the second power line 101. The LCD controller 90 supplies power to the sub-display 21.

Now that the connectors 37 of the first set are connected to the connectors 49 of the second set, the USB interface 22 is connected to the sub-display 21. Hence, the data sent from an external apparatus can be transmitted from the USB interface 22 to the sub-display 21 through the first and second USB positive lines 93 and 103 and the first and second USB negative lines 94 and 104. This transmission of data is performed via the ICH 98. The data is, for example, a signal showing the receipt of an E-mail. Upon receiving this signal, the LCD controller 90 causes the sub-display 21 to display a message showing the receipt of the E-mail.

When the change display unit 13 is rotated again, from the first position S1 to the second position S2, the connectors 37 of the first set are disconnected from the connectors 49 of the second set. As a result, power is no longer supplied to the LCD controller 90. The supply of power to the sub-display 21 is thereby stopped.

In the portable computer 11 described above, which is the second embodiment, the wire 36 of the first set include a first power line 91 that supplies power to the sub-display 21 from the main unit 12. Hence, the first power line 91, which is used only while the display unit 13 remains at the first position S1, need not pass through the hinge unit 14.

The sub-display 21, which is a display, is provided on the upper surface 24 of the display unit 13. Therefore, the user can see the information which sub-display 21 shows while the display unit 13 remains at the first position S1 and closed. Thus, the sub-display 21 can be used only while the display unit 13 stays at the first position S1, and cannot be used while the display unit 13 remains at the second position S2.

The first wires 36 of the first set include the first USB positive line 93 and the first USB negative line 94. The first USB positive line 93 and the first USB negative line 94 transmit and receive data to and from the USB interface 22. The data sent from an external apparatus can therefore be supplied to the sub-display 21 through the USB interface 22. Since the wires 36 of the first set includes a first earth wire 92, the first earth wire 92 can be arranged near the first USB positive line 93 and the first USB negative line 94. The first earth wire 92 can therefore absorb the electromagnetic waves transmitted from, for example, an high-speed USB2.0 interface or the like.

The information-processing apparatus of this invention can be applied not only to the portable computer 11 according to the embodiment described above, but also to other information-processing apparatuses, such as a potable information terminal. In the present embodiment, the display unit 13 can be rotated around the axle of the hinge mechanism. Nevertheless, the present invention can be applied to a portable computer of the tablet type in which the display unit 13 can rotate around the shaft of the which rotates centering on the axle of the hinge unit 14.

In this embodiment, the USB interface 22 is used as an external-connection interface. Instead, an external-connection interface of a different type, such as a D-sub connector or an IEEE1394 connector, can be utilized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.
What is claimed is:

1. An information-processing apparatus comprising:
a main unit which has a holding part;
a display unit which is supported on the main unit by a hinge unit and which is able to rotate between a first position and a second position, the display unit being closed with respect to the main unit while remaining at the first position and being opened with respect to the main unit while remaining at the second position; and
a latch which is provided on the display unit and which is held by the holding part while the display unit remains in the first position,
the latch having a latch part, wires embedded in the latch parts, and first connectors connected to the wires, and
the holding part has second connectors which remains connected to the first connectors while the holding parts is holding the latch.

2. The information-processing apparatus according to claim 1, wherein the first connectors are female-type one, and the second connectors are male-type one.

3. The information-processing apparatus according to claim 1, wherein the wires are used while the display unit remains at the first position.

4. The information-processing apparatus according to claim 1, wherein the display unit has a display, and the wires include a power line which supplies power from the main unit to the display while the display unit remains at the first position.

5. The information-processing apparatus according to claim 1, wherein the display unit has a display, and the wires include a signal line which supplies video data from the main unit to the display while the display unit remains at the first position.

6. The information-processing apparatus according to claim 1, wherein the display unit has an antenna and an amplifier to amplify a signal received by the antenna, and the wires include a signal line which is connected to the amplifier and which supplies a signal from the main unit to the amplifier to turn on or off the amplifier.

7. The information-processing apparatus according to claim 6, wherein the main unit has a power-supply controller which turns on or off the amplifier and a detecting unit to detect that the display unit is at the first position, and the amplifier is turned on by the power-supply controller when the detecting unit detects that the display unit is at the first position and is turned off when the first connectors and the second connectors are disconnected from each other as the display unit moves from the first position to the second position.

8. The information-processing apparatus according to claim 1, wherein the display unit has a display, the main unit has an external-connection interface, the wires include a signal line which is connected to the display and used to exchange data between the external-connection interface and the display.

9. The information-processing apparatus according to claim 1, wherein the wires include a ground line which is connected to the display unit and connects the display unit to the ground with respect to the main unit.
